(19) United States
(12) Patent Application Publication
(10) Pub. No.: US 2017/0182493 A1
(43) Pub. Date: Jun. 29, 2017

(54) THIN-FILM FLOWCELLS

(71) Applicant: QIAGEN Waltham, Waltham, MA (US)

(72) Inventors: Thomas Daniel Perroud, Lexington, MA (US); Michel Georges Perbost, Belmont, MA (US)

(21) Appl. No.: 15/386,490

(22) Filed: Dec. 21, 2016

Related U.S. Application Data
(60) Provisional application No. 62/271,423, filed on Dec. 28, 2015.

(51) Int. Cl. B01L 3/00

(52) U.S. Cl. CPC B01L 3/502715; B01L 2300/123; B01L 2300/168; B01L 2300/0654; B01L 2200/10; B01L 2300/0816; B01L 2200/12; B01L 2400/0487

(57) ABSTRACT

A sequencing instrument including a sequencing stage and a microscope. The sequencing stage has a reference plate with a flat reference surface. The microscope optical axis is perpendicular to the reference surface. The sequencing stage is configured to receive a flexible film having a plurality of DNA templates immobilized on a first side of the film, and to hold the flexible film against the flat reference surface with at least some of the plurality of DNA templates in an object plane that is perpendicular to the microscope's optical axis.

### CROSS REFERENCE TO RELATED APPLICATIONS

This application claims the benefit of U.S. Provisional Application No. 62/271,423, entitled THIN-FILM FLOWCELLS, filed Dec. 28, 2015, the contents of which are incorporated herein by reference.

### BACKGROUND OF THE INVENTION

Field of the Invention

The present invention relates generally to instruments for performing sequencing-by-syntheses or other sequencing processes, and more particularly to flowcells used in such instruments.

Description of the Related Art

DNA sequencing instruments are used to determine DNA molecular sequences. Such instruments are useful for clinical studies, diagnostics, so-called “personalized medicine” (medical treatment tailored to an individual's genetic content or the like), and so on. Current instruments for performing DNA sequencing use a variety of technologies to analyze the base pairs that form the DNA sequence. For example, some instruments perform sequencing on single-stranded DNA molecule fragments (DNA templates) that are fixed in place inside a flowcell. The flowcell is essentially a small chamber in which the DNA templates are subjected to a series of nucleobase extension processes. Each successive extension is detected to determine the base pair sequence of each DNA template. The flowcell provides an environment to hold the DNA templates during the extension process, and also during the inspection process to read each extended base pair.

Many sequencing-by-synthesis instruments use an optical system such as a microscope to detect the nucleobase extensions, although non-optical systems are also known. A typical optical instrument uses visible chemical labels to determine the identity of each extended base pair. For example, each nucleobase that makes up the DNA molecule (adenine, guanine, cytosine and thymine) may be labeled with a unique fluorescent probe that is visible through the microscope. The label is read each time the DNA template is extended, and then the label is removed to make way for the next base pair extension.

In modern “next-generation” instruments, millions of DNA templates may be processed simultaneously in a single flowcell. The DNA templates may be randomly ordered within the flowcell, or ordered at specific predetermined locations. A variety of flowcell designs have been developed to hold the immobilized DNA templates, but they usually include certain common features. A typical flowcell includes a rigid flow channel, an optically transparent cover that encloses the channel, and fluid inlets and outlets through which the appropriate reagents are passed to control the growth and extension of the DNA templates. Example of such flowcells are found in U.S. Pat. Nos. 8,481,259, 8,940,481 and 9,146,248 and U.S. Patent Application Publication Nos. 2009/0298131 and 2014/0267669, all of which are incorporated herein by reference.

Sequencing instruments that use optical detection of the base pair extensions must be able to detect labels that are very small and emit very little light. Microscope-type optics often are employed to obtain the desired magnification, but such instruments must operate at extremely high tolerances to account for the high magnification, low light environment, and need for optical accuracy to distinguish between the different DNA templates. In this environment, the optical path typically has a very shallow depth of field (i.e., distance between near and far objects that are in focus or at least acceptably sharp). In this environment, any DNA templates immobilized on the flowcell that are not within the depth of field are likely to be unreadable. Thus, a typical flowcell is constructed from a rigid, thermally and dimensionally stable material manufactured to very high tolerances, to maximize the flatness of the surface to which the DNA templates are immobilized. This maximizes the population of DNA templates that will be in focus during the optical read process. Flowcells also typically have high optical transparency (at least to the wavelengths of light that are used in the reading process), efficient heat transfer properties to support the chemical reactions performed within the flowcell, multilayer coatings to improve optical fidelity, in situ DNA template sites or scaffolds, and so on.

The inventors have determined that there continues to be a need to advance the state of the art of flowcells for sequencing instruments and similar devices.

### SUMMARY

In one exemplary aspect, there is provided a flowcell system for a sequencing instrument, the flowcell system including a fluid inlet configured to receive one or more liquid reagents, a fluid outlet configured to pass the one of more liquid reagents, and a channel extending between and fluidly connecting the fluid inlet and the fluid outlet, in which at least a portion of the channel comprises a film comprising a flexible material configured to receive a plurality of DNA templates immobilized thereon.

In another exemplary aspect, there is provided a flowcell for a sequencing instrument. The flowcell has a flowcell plate comprising a rigid material, at least a portion of the flowcell plate comprising a transparent plate region, a film of flexible material attached at a perimeter region of the film to the flowcell plate, with at least a portion of the film facing the transparent plate region, the film being movable in a direction away from the flowcell plate to form a channel between the flowcell plate and the film. The flowcell may have a fluid inlet configured to receive one or more liquid reagents, and a fluid outlet configured to pass the one of more liquid reagents. At least one of the fluid inlet and the fluid outlet may be a respective passage through the flowcell plate. The film may be a polymer, such as a cyclic olefin copolymer. The film may have a thickness of 1 micrometer to 100 micrometers, 4 micrometers to 50 micrometers, or 10 micrometers to 20 micrometers. The film may have one or more coatings such as: a chemical treatment, a DNA template scaffold, or an optical coating comprising visible markers. A surface of the film facing the flowcell plate may have a plurality of DNA templates immobilized thereon. The flowcell plate may be configured and dimensioned to fit on a portion of an associated sequencing instrument, and the film may be configured to be placed into contact with a reference surface on the associated sequencing instrument upon application of a differential pressure across the film.

In another exemplary aspect, there is provided a flowcell for a sequencing instrument. The flowcell has: a first film of a first flexible material, at least a portion of the first film having a transparent film region; a second film of a second flexible material, the second film being connected to the first film at a perimeter edge with at least a portion of the second film facing the transparent film region; a fluid inlet operatively associated with the flowcell; and a fluid outlet operatively associated with the flowcell. Respective portions of the first film and the second film are movable away from each other to form a channel extending from the fluid inlet to the fluid outlet. The first film and the second film may be a cyclic olefin copolymer. The first film and the second film may each have a thickness of 1 micrometer to 100 micrometers, 4 micrometers to 50 micrometers, or 10 micrometers to 20 micrometers. At least one of the first film and the second film may have one or more coatings, such as a chemical treatment, a DNA template scaffold, or an optical coating comprising visible markers. At least one of the first film and the second film may have a respective plurality of DNA templates immobilized thereon. Each of the first film and the second film may have a respective plurality of DNA templates immobilized thereon. The first film and the second film may be separate sheets of film material bonded together at the perimeter edge, a single sheet of folded film material, or a single tube of film material. The flowcell may be configured and dimensioned to fit on a portion of an associated sequencing instrument, and the first film may be configured to be placed into contact with a first reference surface on the associated sequencing instrument upon application of a differential pressure across the first film, and the second film may be configured to be placed into contact with a second reference surface on the associated sequencing instrument upon application of a differential pressure across the second film.

In another exemplary aspect, there is provided a flowcell for a sequencing instrument. The flowcell has: a film of flexible material; a cover assembly having a cavity facing a first side of the film; and a reference plate facing a second side of the film that is opposite the first side of the film. At least one of the reference plate and the cover assembly is selectively movable to hold the film between the cover assembly and the reference plate to form a passage within the cavity that extends from a fluid inlet to a fluid outlet. The film may be a cyclic olefin copolymer. The film may have a thickness of 1 micrometer to 100 micrometers, 4 micrometers to 50 micrometers, or 10 micrometers to 20 micrometers. The film may have one or more coatings such as: a chemical treatment, a DNA template scaffold, or an optical coating comprising visible markers. A surface of the film may have a plurality of DNA templates immobilized thereon. The cover assembly may include a cover plate, a least a portion of the cover plate being a transparent cover region, and a gap spacer extending from the cover plate to form the cavity. The fluid inlet and the fluid outlet may be passages through the cover assembly. The reference plate may have one or more air passages connected to an air pump to generate a negative pressure on the second side of the film, to thereby draw the film into contact with the reference plate. The film may be a discrete portion of a supply of film, which may be a spooled roll of film configured to be rotated to move the discrete portion of the supply of film out from between the cover assembly and the reference plate.

In another exemplary aspect, there is provided a method for providing a flat flowcell object plane for a sequencing instrument. The method includes: providing a film comprising a flexible material configured to receive a plurality of DNA templates on a first side of the film; and pressing a second side of the film opposite the first side of the film against a flat reference surface. The film may be a polymer, such as a cyclic olefin copolymer. The film may have a thickness of 1 micrometer to 100 micrometers, 4 micrometers to 50 micrometers, or 10 micrometers to 20 micrometers. The film may have one or more coatings such as: a chemical treatment, a DNA template scaffold, or an optical coating comprising visible markers. The method also may include immobilizing a plurality of DNA templates to the film. The method also may include attaching the film to a flowcell plate of rigid material with the first side of the film facing the flowcell plate, such that the film and the flowcell plate form a passage between a fluid inlet and a fluid outlet, at least when a differential pressure is applied to the film to press the second side of the film against the flat reference surface. The method also may include: providing a second film of a second flexible material adjacent and connected to the film at a perimeter edge to form a passage between a fluid inlet and a fluid outlet; and applying the differential pressure to the second film to press the second film against a second flat reference surface. The method also may include holding the film between the flat reference surface and a cover assembly comprising a cavity, the cavity and the film together forming a passage between a fluid inlet and a fluid outlet. The method also may include: moving the cover assembly away from the flat reference surface; removing the film from between the flat reference surface and the cover assembly; placing a new film between the flat reference surface and the cover assembly; and moving the cover assembly towards the flat reference surface to form a new flowcell. In the method, pressing the second side of the film opposite the first side of the film against the flat reference surface may be done by applying a differential pressure across the first side of the film and the second side of the film. Applying a differential pressure may be done by exposing the second side of the film to a reduced pressure, exposing the first side of the film to an increased pressure, or both. Pressing the second side of the film opposite the first side of the film against the flat reference surface may be done by stretching the film against the flat reference surface.

In another exemplary aspect, there is provided a flowcell for a sequencing instrument. The flowcell has a film comprising a flexible material having a plurality of DNA templates immobilized thereon. The film may be a cyclic olefin copolymer. The film may have a thickness of 1 micrometer to 100 micrometers, 4 micrometers to 50 micrometers, or 10 micrometers to 20 micrometers. The film may have one or more coatings such as: a chemical treatment, a DNA template scaffold, or an optical coating comprising visible markers. The film may be movable to position at least some of plurality of DNA templates along a flat object plane. The film may be configured to be moved adjacent a flat reference surface to position the DNA templates along a flat object plane. The flowcell also may include a flowcell plate of rigid material, at least a portion of the flowcell plate comprising a transparent plate region; and the film may be attached at a perimeter region of the film to the flowcell plate, with at least a portion of the film facing the transparent plate region, the film being movable in a direction away from the flowcell plate to form a channel between the flowcell plate and the film. The flowcell film may include: a first film; a second film connected to the first film at a perimeter edge with at least a portion of the second film facing the first film; a fluid inlet operatively associated with the flowcell; and a fluid outlet operatively associated with the flowcell; and respective portions of the first film and the second film are movable away from each other to form a channel extending from the fluid inlet to the fluid outlet. The first film and the second film may be separate sheets of film material bonded together at the perimeter edge, a single sheet of folded film material, or a single tube of film material. The flowcell may include: a cover assembly having a cavity facing a first side of the film having the DNA templates immobilized thereon; and a reference plate facing a second side of the film that is opposite the first side of the film; wherein at least one of the reference plate and the cover assembly is selectively movable to hold the film between the cover assembly and the reference plate to form a passage within the cavity that extends from a fluid inlet to a fluid outlet. The film may be a discrete portion of a supply of film material.

In another exemplary aspect, there is provided a sequencing instrument having: sequencing stage having a reference plate having a flat reference surface; and a microscope having an optical axis the is perpendicular to the flat reference surface. The sequencing stage is configured to receive a flexible film having a plurality of DNA templates immobilized on a first side of the film, and to hold the flexible film against the flat reference surface with at least some of the plurality of DNA templates in an object plane that is perpendicular to the optical axis. The flat reference surface may have a flatness of 0.05%, which is calculated as the maximum “peak to valley” height variation over a predetermined span of the surface (e.g., a variation in height of no greater than 0.025 millimeters over a distance of 50 millimeters). Other preferred flatness values and other measurement techniques (e.g., the arithmetic mean of the departures of the roughness profile from the mean line) may be used in other embodiments. The sequencing stage may have more air passages connected to at least one vacuum source to generate a reduced pressure on a second side of the film opposite the first side of the film, to create a differential pressure to press the second side of the film against the flat reference surface. The air passages may pass through the flat reference surface. The flexible film may be provided on a flowcell plate of a rigid material, the film being attached at a perimeter region of the film to the flowcell plate, with the first side of the film facing the flowcell plate, the film being movable in a direction away from the flowcell plate to form a channel between the flowcell plate and the film. The film may include: a first film; a second film connected to the first film at a perimeter edge with at least a portion of the second film facing the first side of the first film; and wherein respective portions of the first film and the second film are movable away from each other to form a channel extending between the first film and the second film. The sequencing stage may include a cover assembly comprising a cavity facing the first side of the film, wherein at least one of the reference plate and the cover assembly is selectively movable to hold the film between the cover assembly and the reference plate to form a passage within the cavity that extends from a fluid inlet to a fluid outlet. The cover assembly may include a cover plate and a gap spacer extending from the cover plate to form the cavity. The fluid inlet and the fluid outlet may be passages through the cover assembly. The film may be a discrete portion of a supply of film material.

Other alternatives will be apparent to persons of ordinary skill in the art in view of the present disclosure.

The recitation of this summary of the invention is not intended to limit the claims of this or any related or unrelated application. Other aspects, embodiments, modifications to and features of the claimed invention will be apparent to persons of ordinary skill in view of the disclosures herein.

### BRIEF DESCRIPTION OF THE DRAWINGS

A better understanding of the exemplary embodiments may be understood by reference to the attached drawings, in which like reference numbers designate like parts. The drawings are exemplary and not intended to limit the claims in any way.

FIG. 1 is an exploded isometric view of a first exemplary embodiment of a flowcell and associated devices.

FIG. 2 is a cross-section elevation view of the first exemplary embodiment.

FIG. 3 is a partially cut away plan view of a second exemplary embodiment of a flowcell and associated devices.

FIGS. 4a and 4b are isometric views of the second exemplary embodiment in two different operative states.

FIGS. 5a and 5b are cross-section elevation views of a third exemplary embodiment of a flowcell and associated devices, shown in two different operative states.

FIG. 6 is a schematic drawing of an exemplary instrument used with various exemplary embodiments.

### DETAILED DESCRIPTION

The inventors have determined that precision-manufactured flowcells used in typical sequencing instruments significantly increase the cost of operating such instruments. In particular, a single instrument may require a number of flowcells to hold the DNA templates that are processed during each automated run, and such flowcells may not be reusable. Each flowcell must be made to stringent tolerances to provide one or more flat reference planes to hold the DNA templates, in order to ensure proper optical reading within the narrow depth of field of typical optical instruments. The flowcells also may require expensive and/or difficult to machine materials.

An exemplary existing flowcell is formed of glass. While glass flowcells are functional, they are not particularly cost effective given the complexity of the process to make the multi-layered optical coatings that are used on the glass. In addition, they have relatively limited manufacturing scalability. Plastic flowcells are also known, and provide relatively high scalability and potentially low base costs by using injection molding techniques. However, plastic flowcells are still difficult to manufacture to high physical tolerances due to the rapid non-homogenous cooling that occurs when the parts are ejected from the molding cavity. Also, the minimum thickness of an injection-molded plastic part (˜0.5 mm) decreases the efficiency of heat transfer into and out of the flowcell, which can impair the chemical processes performed within the flowcell. Another type of known flowcell uses a hybrid construction, such as a metallic base (e.g., titanium-silicon alloy) and a transparent cover (e.g., borosilicate glass). Such flowcells can use expensive materials and be expensive to manufacture, and the heterogeneous nature of the components can cause difficulties, such as different surface energies or thermal expansion coefficients causing delamination. The use of heterogeneous materials to form the flowcell also makes it more challenging to select the proper surface chemistry to immobilize DNA templates on both surfaces (which may be desirable in some cases, but is not always required), thus potentially limiting sequencing to a single surface within the flowcell.

The inventors have determined that next-generation sequencing instruments can benefit from using a more cost-effective flowcell based on thin films, such as thin plastic films that are compatible with high-volume film-coating industrial processes and the like. Descriptions of particular exemplary embodiments follow, but it will be appreciated that the scope of the invention is not limited to any particular example, and the examples may be combined and modified in various ways, as will be understood by one of ordinary skill in the art in view of the present disclosure.

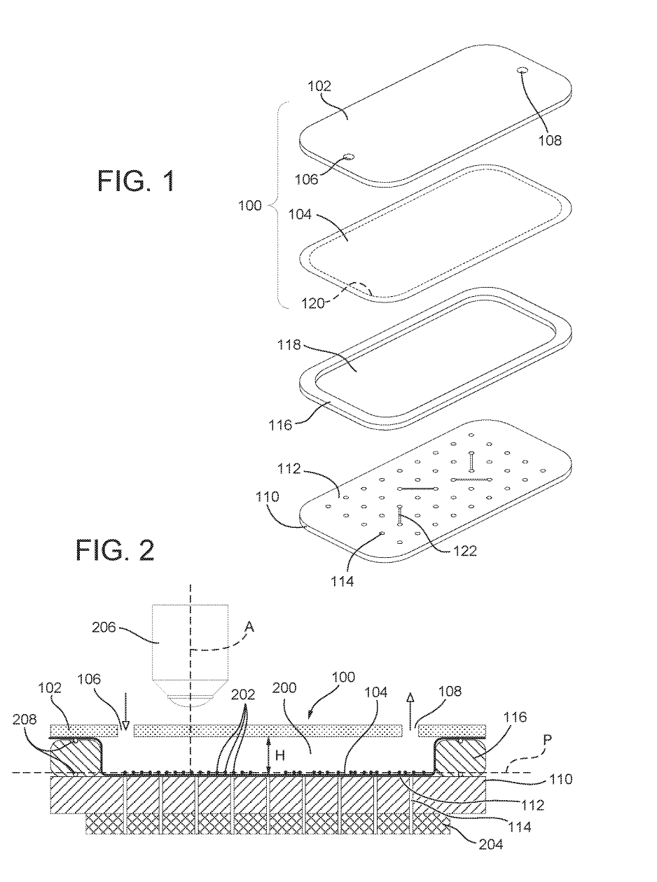

FIGS. 1 and 2 illustrate a first exemplary embodiment of a flowcell 100 comprising a rigid flowcell plate 102 and a thin film 104. The flowcell plate 102 may include at least one fluid inlet 106 and at least one fluid outlet 108. The flowcell plate 102 may comprise glass (e.g., borosilicate glass or the like), plastic (e.g., polycarbonate or the like), or other suitable materials. The flowcell plate 102 also preferably is highly optically transparent in the range of wavelengths used in the optical reading process and has low autofluorescence properties. To this end, the flowcell plate 102 may be made entirely of a transparent material, but it is only necessary for at least a portion of the flowcell plate 102 overlying the film 104 to be transparent. The flowcell plate 102 also may be treated with suitable coatings to enhance optical performance, as known in the art. The flowcell plate 102 may be made by any suitable process, such as injection molding and machining for plastic or float casting for glass. For example, it is expected that a plastic flowcell plate 102 may be conveniently formed with suitable optical properties using an injection molding process in which the fluid inlet 106 and fluid outlet 108 are simultaneously formed with the rest of the flowcell plate 102. The fluid inlet 106 and fluid outlet 108 also may include integral or attached fittings for forming a fluid connection to reagent supply and waste conduits in the instrument. It is also envisaged that the fluid inlet 106 and fluid outlet 108 may remain open at all times, or may be closed or sealed at times.

The film 104 comprises a flexible thin film material that is attached to the bottom face of the flowcell plate 102 along a perimeter region 120 that surrounds the fluid inlet 106 and the fluid outlet 108, such that reagents passing through the fluid inlet 106 enter a space between the film 104 and the flowcell plate 102 before exiting through the fluid outlet 108. The film 104 preferably comprises a material such as a cyclic olefin copolymer. Exemplary cyclic olefin copolymers include TOPAS™ available from TOPAS Advanced Polymers, Inc. of Florence, Ky., USA, and ZEONOR™ available from Zeon Chemicals, L.P. of Louisville, Ky., USA. Other possible materials include polypropylene, polyethylene, cyclic olefin polymers (e.g., ARTON™ available from Japan Synthetic Rubber Corporation of Japan, and ZEONEX™ available from Zeon Chemicals, L.P. of Louisville, Ky., USA), polyethylene terephthalate, fluorinated ethylene propylene, and other materials that can be formed into thin films suitable for the purposes described herein.

The film 104 may be selected to have certain properties that may be beneficial in the applications described herein. For example, the film 104 preferably has low autofluorescence properties (i.e., it does not generate a significant fluorescing background during the base pair reading process). The film 104 also preferably is flexible and readily articulated using a vacuum, as described in more detail below. The film 104 may have a thickness of 1-100 micrometers (“μm”), and more preferably 4-50 μm, and most preferably 10-20 μm. Such thicknesses are expected to provide suitable strength, while allowing manipulation using a pressure differential and providing relatively efficient heat transfer. It is also preferred for the film 104 to have a fairly uniform film thickness, and low heat shrinkage properties. For example, in one embodiment, the film 104 may shrink less than 2% in the machine direction and transverse direction, as measured by increasing the temperature of the film to 150° Celsius for fifteen minutes or by using other tests, such as ASTM International's Active Standard ASTM D2732 for measuring unrestrained linear thermal shrinkage. Other values and test methods may be used in other embodiments. The film 104 also may be heat treated (e.g., annealed) prior to use to help homogenize its physical properties prior to being incorporated into the flowcell.

The film 104 is connected to the perimeter of the flowcell plate 102 to form a fluid-tight channel 200 extending from the fluid inlet 106 to the fluid outlet 108. The film 104 may be permanently connected to the flowcell plate 102 by thermal bonding, an adhesive bond, ultrasonic welding, or the like. Alternatively, the film 104 may be temporarily connected to the flowcell plate 102 by pinching the film 104 to the perimeter of the flowcell plate 102 using a suitable clamp structure.

One or more coatings or treatments may be applied to the film 104. For example, the film 104 may be coated with several layers of chemistries using various techniques. Chemistries may be applied by various roll-to-roll film processes, such as slot die coating, curtain coating, gravure coating, flexography printing and rotogravure printing. The coatings may be selected to perform various functions. For example, an optical coating comprising visual markers (e.g., a grid pattern or ordered spots) may be applied to the film 104 to help provide rapid autofocusing. A coating or treatment also may be provided to form a scaffold for growing DNA template colonies, and such a scaffold may be patterned to minimize overlap of the DNA template colonies while maximizing the density of the colonies on the film 104. For example, a hexagonal scaffold pattern may be thermoformed into the film 104 to provide physical locations to capture the DNA templates, or the film 104 may be treated with a pattern of chemical bonding sites to immobilize the DNA templates in particular locations, and so on. The film 104 also may be treated by structural manipulation, such as by forming wells using embossing techniques or by adding a grid-like layer, to assist with positioning or immobilizing DNA template colonies or provide other benefits. Other alternatives will be apparent to persons of ordinary skill in the art in view of the present disclosure.

As shown in FIG. 2, the film 104 portion of the flowcell 100 provides a substrate surface upon which the DNA templates 202 are immobilized. The DNA templates 202 may be in an ordered pattern (such as shown on the left-hand side of FIG. 2), or may be randomly distributed (such as shown on the right-hand side of FIG. 2). Of course, some random distribution may occur even when the flowcell 100 is configured to provide an ordered distribution of DNA templates by way of template scaffold coatings, bead wells, and the like.

The flowcell 100 is used in conjunction with a reference plate 110. The reference plate 110 is formed with a flat reference surface 112, against which the film 104 is pressed during at least some phases of instrument operation. The overall flatness of the object plane upon which the DNA templates is immobilized (i.e., the upper surface of the film 104) is defined by the flatness of the reference surface 112 and the thickness uniformity of the film 104. This provides a distinct advantage over prior flowcell designs, in which each flowcell was manufactured to extremely high tolerances to obtain the desired flatness, because only a single reference surface 112 needs to be manufactured, and the flowcells 100 need only have film materials of a relatively consistent thickness to assure placement of the DNA templates 202 in the imaging object plane P.

The reference surface 112 may comprise a metallic material (e.g., titanium-silicon alloy) that is machined or otherwise formed to have a very high flatness (i.e., very low variation in surface flatness). Alternatively, the reference surface 112 may comprise a naturally flat material such as graphene sheet or a cleaved mica surface. In still other embodiments, the reference surface 112 may comprise a glass, plastic or ceramic sheet that is machined or otherwise manufactured to the desired flatness. In a preferred embodiment, the reference surface 112 comprises a metallic material, such as titanium silicon, having a high thermal conductivity and machined to a flatness of 0.05%, which is calculated as the maximum “peak to valley” height variation over a predetermined span of the surface (e.g., a variation in height of no greater than 0.025 millimeters over a distance of 50 millimeters). Other materials, flatness values and measurement techniques (e.g., the arithmetic mean of the departures of the roughness profile from the mean line) may be used in other embodiments.

The film 104 may be pressed against the reference surface 112 using a vacuum differential applied in an enclosed space between the film 104 and the reference surface 112. For example, the reference plate 110 may include a number of vacuum passages 114 passing through the reference plate 110, which are connected to a vacuum pump (not shown) to generate a negative pressure on the lower surface of the film 104. The vacuum passages 114 may comprise simple circular openings, or other suitable shapes. The passages 114 also may comprise grooves 122 along the reference surface 112. Any suitable combination of openings and/or grooves may be used in different embodiments. This negative pressure creates a pressure differential that urges at least a portion of the film 104 into intimate contact with the reference surface 112. It is not necessary for the entire film 104 to be pressed against the reference surface 112, but those portions that are not pressed against the reference surface may not lie in a common object plane with the remaining portions of the film 104 and may not be in focus during the base pair reading process.

In one embodiment, the pressure differential may be 0.5-5 pounds per square inch (“psi”), and more preferably 1-2 psi, provided as a pressure drop on the bottom of the film 104 relative to the top of the film 104. It is also envisioned that a positive pressure may be applied to the upper surface of the film 104, instead of (or along with) applying a vacuum to the bottom surface of the film 104. A positive pressure may be provided, for example, by pressurizing the reagents that pass through the channel 200 to a desired amount to generate a sufficient pressure differential to press at least a portion of the film 104 into intimate contact with the reference surface 112. Still further, in some embodiments reagents may be drawn through the channel 200 under negative pressure, in which case the pressure differential may be provided by exceeding the negative pressure generated within the channel 200 by an amount sufficient to obtain a pressure differential that moves the film 104 into position against the reference surface 112. Other alternatives will be apparent to persons of ordinary skill in the art in view of the present disclosure.

It will be appreciated from the foregoing description that the pressure differential urges the film 104 away from the flowcell plate 102 to form the channel 200. The pressure differential may elastically or plastically deform the film 104 (or both) to obtain the desired flowcell channel 200 shape. Such deformation may be assisted by heating the film 104. For example, the flowcell 100 may be placed in a heating block and subjected to a pressure differential to form the general shape of the channel 200 before the sequencing process begins, or this may be done as a step of the sequencing process. The deformation also may be assisted by pre-forming the film 104 to be shaped like the channel 200 in advance of attaching the film 104 to the flowcell plate 102. This may be accomplished by vacuum-forming or embossing the film 104 into the approximate shape of the channel 200 or using other known manufacturing methods.

To allow in situ sequencing, the reference plate 110 preferably is connected to a heating and/or cooling system. For example, the reference plate 110 may be attached to or formed as part of a thermoelectric heat pump 204 (i.e., a so-called “Peltier” device). The heat pump 204 can be activated to heat (and optionally cool) the reference plate 110 to heat (and optionally cool) the contents of the chamber 200. In a preferred embodiment, the heat pump 204 and reference plate 110 are configured to regulate the temperature in the channel 200 in the range of 4°-99° Celsius, and more preferably in the range of room temperature (nominally 22° Celsius) to 80° Celsius.

The flowcell 100 also may be used in conjunction with a gap spacer 116 that fits between the flowcell 100 and the reference plate 110. The gap spacer 116 comprises a flat, and preferably continuous wall that forms an opening 118 extending vertically through the gap spacer 116. The gap spacer 116 may have precision manufactured upper and lower faces to abut the flowcell 100 and reference plate 110, respectively. As shown in FIG. 2, the gap spacer 116 may be used to define the height H of the flowcell channel 200. In some embodiments, the channel height H may be 10-200 μm, and more preferably 50-150 μm, and most preferably 80-120 μm.

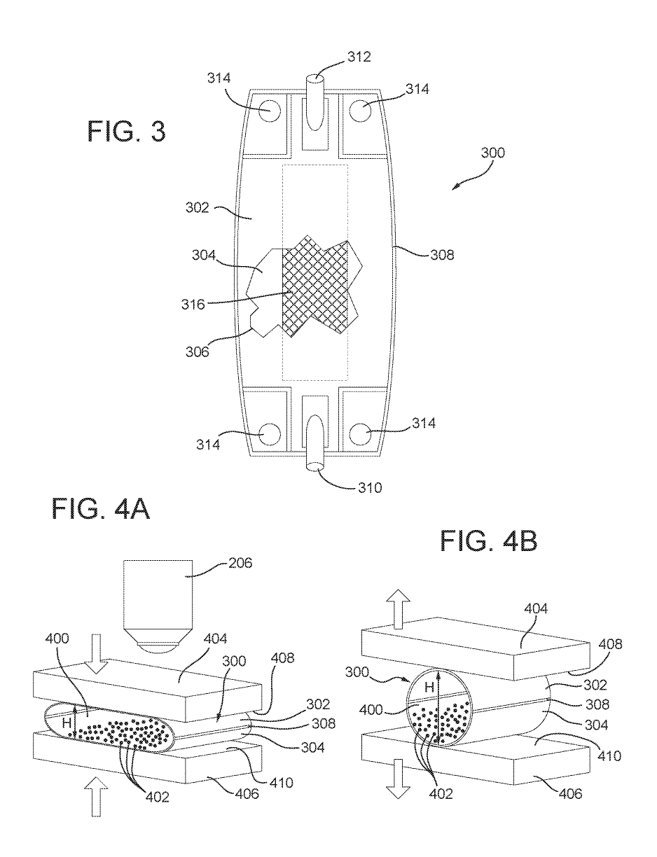

The gap spacer 116 may be provided as a separate part, as shown. In this embodiment, the gap spacer 116 may be replaceable to change the height of the channel 200 between sequencing operations. Also, if it is desired to change the height of the channel during the sequencing operation, the gap spacer 116 may be movably connected to the reference plate 110, such as by being mounted on a vertically-moving rack. Such movement may be desirable, for example, to change the channel height H to periodically reduce flow resistance such as described in more detail with respect to the embodiment of FIGS. 3-4B. In such an embodiment, the reference plate 110 may, for example, be shaped to fit entirely within the gap spacer opening 118, to allow relative movement between the reference plate 110 and the gap spacer 116. Alternatively, the gap spacer 116 may be formed as a permanent part of the reference plate 110 or flowcell 100. For example, the gap spacer 116 may be bonded or otherwise attached to the bottom face of the flowcell, and used to clamp the film 104 in place against the flowcell plate 102. As another example, the gap spacer 116 may be machined as an integral part of the reference plate 110. The gap spacer 116 preferably is formed from a generally rigid material, such as metal or plastic, and the material may be selected to minimize thermal expansion and contraction that might affect the sequencing and base pair reading operations.

The shape of the gap spacer opening 118 may be selected to define the shape and size of the channel 200, particularly in embodiments in which the film 104 is pliable enough to form tightly into the space between the flowcell plate 102 and the reference plate 110 when the differential pressure is applied. For example, the gap spacer opening 118 may be configured as a narrow channel 200 between the fluid inlet 106 and the fluid outlet 108, or it may form a relatively wide channel 200. The channel's shape can also be varied as desired. For example, the shown channel 200 has a rectangular shape that fills the opening 118. As another example, the channel 200 may have a “dog-bone” or “dumbbell” shape having relatively large reservoirs adjacent the fluid inlet 106 and fluid outlet 108 and a relatively narrow passage extending between the reservoirs. It is also envisioned that the channel 200 may be divided into multiple separate channels, such as by providing ridges extending upwards from the reference plate 110 that cause the film 104 to deform into separate passages when the differential pressure is applied. Changing the size of the channel 200 can affect the number of sequencing operations performed in the flowcell, as well as the rate of reagent consumption.

The gap spacer 116 also may cooperate with the other parts to form a generally sealed chamber in which the lower surface of the film 104 is contained, so that the vacuum can properly pull the film 104 against the reference surface 112. To this end, the gap spacer 116 may include seals 208 that form an air-tight seal against the flowcell 100 and the reference plate 110. The gap spacer 116 also may include one or more air passages (similar to air passages 114) through which a vacuum may be applied to the lower surface of the film 104. Other alternatives will be apparent to persons of ordinary skill in the art in view of the present disclosure. For example, a seal may be provided on the bottom of the flowcell plate 102 to engage a corresponding surface of the gap spacer 116 or the reference plate 110 to form a sealed vacuum chamber.

In use, the gap spacer 116 is positioned on the reference plate 110, and the flowcell 100 is placed on the gap spacer 116 with the film 104 facing the reference surface 112. A clamp or other mechanism may be provided to hold the flowcell 100 in place. A pressure differential is then applied to the two sides of the film 104, such as by drawing a vacuum through the vacuum passages 114 through the reference plate 110. The pressure differential urges at least an operative portion of the film 114 (i.e., the portion that will be used for the sequencing base pair reads) into contact with the reference surface 112. Thus, the operative portion of the film 104 assumes a flat shape as defined by the flatness of the reference surface 112 and the thickness uniformity of the film 104.

The sequencing process preferably commences after the film 104 is flat against the reference surface 112. The sequencing process may follow any suitable protocol, and may include processing steps such as: immobilizing the DNA templates on the film 104, passing reagents through the channel 200, heating and/or cooling the contents of the channel 200, and so on. The specific details of the chemical reactions are not relevant to the present disclosure, and are not described herein. However, examples of sequencing processes are described in U.S. Patent Application Publication Nos. 2013/0301888, 2013/0316914, and 2014/0045175, as well as U.S. Pat. No. 9,017,973, all of which are incorporated herein by reference. It will also be appreciated that, in some embodiments, some steps of the process may be performed before the film 104 is pressed to the reference surface 112. For example, the DNA templates 202 may be immobilized to the film 104 before the film 104 is connected to the flowcell plate 102. As another example, certain chemical reactions may be performed within the flowcell channel 200, and then the differential pressure is applied to flatten the film 104 before performing each base pair read. Other alternatives will be apparent to persons of ordinary skill in the art in view of the present disclosure.

Periodically during the sequencing process, a microscope 206 or other optical instrument is used to read the extended base pairs on the DNA templates 202. During this read step, the flat reference surface 112 and relatively uniform thickness of the film 104 cooperate to provide a flat object plane P that is oriented perpendicular to the microscope's optical axis A. The microscope 206 may be manipulated to align its focus plane with the object plane P, such that the DNA templates 202 are within the depth of focus of the microscope 206. Providing a flat object plane P increases the population of DNA templates that will be within the depth of field of the microscope, which enhances the ability to accurately read a greater number of base pair extensions.

The foregoing embodiment can provide certain benefits over conventional precision-manufactured flowcells. For example, the flowcell 100 may use a relatively inexpensive film in conjunction with a single precision-manufactured reference surface 112 on the instrument to provide a uniform and flat surface to facilitate the base pair read process. This is expected to reduce costs and possibly improve performance as compared to systems that use flowcells having integral precision-manufactured flat surfaces. It is also expected that the flowcells 100 can be made relatively quickly using straightforward manufacturing techniques, which can increase the production rate and availability of the flowcells 100.

While the benefit of reducing the need to precision manufacture the flowcell 100 is desirable, it will nevertheless be appreciated that, in some embodiments, the flowcell 100 may be provided with a precision-manufactured flat surface on the bottom of the flowcell plate 102, so that this surface can also be used to hold immobilized DNA template colonies in a common plane for imaging. Other alternatives will be apparent to persons of ordinary skill in the art in view of the present disclosure.

A second embodiment of a flowcell 300 is illustrated in FIGS. 3-4B. This flowcell 300 comprises an upper film 302 and a lower film 304. In FIG. 3, a portion 306 of the upper film 302 has been cut away for illustration purposes, to show the lower thin film 304. The upper film 302 and lower film 304 are attached to each other around a perimeter edge 308. In this embodiment, the upper film 302 and lower film 304 are separate sheets of material that are joined together, but in other embodiments the films 302, 304 may be separate portions of a single sheet that is folded over onto itself, with the fold forming part of the perimeter edge. The films 302, 304 also may be provided as a continuous tube of material that has a continuous surface that forms the side portions of the perimeter edge 308.

The flowcell 300 also includes a fluid inlet 310 and a fluid outlet 312. The fluid inlet 310 and fluid outlet 312 may be formed as passages through the upper film 302 (as shown), as passages through the lower film 304, as fixtures (e.g., tubes) that are captured in place between the upper film 302 and the lower film 304, or using other suitable constructions or combinations of constructions. In the shown embodiment, the fluid inlet 310 and fluid outlet 312 are provided as injection molded tubes having flanges that are bonded to respective openings through the film, but other constructions may be used. For example, the fluid inlet 310 and fluid outlet 312 may comprise self-healing rubber blocks through which needles are passed to inject and remove reagents.

The perimeter edge 308 joins the upper film 302 and lower film 304 to form a channel 400, located between the upper film 302 and lower film 304, which extends from the fluid inlet 310 to the fluid outlet 312. In this example, the perimeter edge 308 has an elongated cross shape, but a rectangular shape, oval shape, or other shapes may be used in other embodiments. For example, the flowcell 300 may include a “dog-bone” or “dumbbell” shape. The flowcell 300 also may include bonded strips that extend along the flow direction of the flowcell 300 to provide multiple parallel channels 400.

In this embodiment, at least one of the upper film 302 and the lower film 304 (preferably the upper film 302) is optically transparent in the wavelengths used in the base pair reading process. The upper film 302 and lower film 304 also may be identical materials, or may be different. The upper film 302 and lower film 304 may comprise film materials (e.g., cyclic olefin copolymers, etc.) and chemical coatings and treatments as described above, or other suitable materials and coatings and treatments. The outer perimeter 308 may be a permanent bond formed by an adhesive bond, ultrasonic welding, heat welding, or by other suitable processes and materials. The outer perimeter 308 also may be a temporary bond formed by pinching the films 302, 304 together between appropriately-shaped mandrels, then releasing the mandrels and removing the films 302, 304 after the sequencing and reading process is complete. If desired, the flowcell 300 may include additional features, such as anchor holes 314 that fit over associated pins (not shown) on the instrument to hold the flowcell 300 in place, or that may be used to otherwise manipulate the flowcell 300.

One or both of the upper film 302 and the lower film 304 also may be treated with chemical coatings or other treatments, such as described above in relation to the first embodiment. For example, the lower film 304 may include a region 316 that is treated with a DNA template scaffold, so that DNA templates 402 only bind to this portion of the flowcell channel 400. Alternatively, DNA templates 402 may be immobilized on the inner surfaces of both the upper film 302 and the lower film 304, which maximizes the number of DNA template colonies available for base pair extension and reading. In this embodiment, the upper film 302 and lower film 304 may have identical material compositions and surface treatments to provide identical surfaces for immobilizing and imaging the DNA templates 402.

The flowcell 300 is used in conjunction with an upper reference plate 404 and a lower reference plate 406. At least one of the upper reference plate 404 and the lower reference plate 406 is optically transparent in the wavelengths used in the base pair reading process. The lower face of the upper reference plate 404 comprises a flat upper reference surface 408 that is manufactured to have a relatively high flatness. Similarly, the upper face of the lower reference plate 406 comprises a flat lower reference surface 410 that is manufactured to have a relatively high flatness. In a preferred embodiment, the upper reference surface 408 and lower reference surface each have a flatness of 0.05%, which is calculated as the maximum “peak to valley” height variation over a predetermined span of the surface (e.g., a variation in height of no greater than 0.025 millimeters over a distance of 50 millimeters). Other preferred flatness values and other measurement techniques (e.g., the arithmetic mean of the departures of the roughness profile from the mean line) may be used in other embodiments. However, if it is desired to immobilize DNA templates only on one of the films 302, 304, then it would only be necessary to provide a flat reference surface on one of the reference plates 404, 406. One or both of the reference plates 404, 406 may be connected to or formed as part of a thermoelectric heat pump or similar device, such as described above.

The upper reference plate 404 and lower reference plate 406 preferably are provided as part of the sequencing instrument, and they may be integrally formed with the instrument or provided as replaceable parts. The reference plates 404, 406 may be made of any suitable material, such as those described previously herein in relation to the first exemplary embodiment, but it will be understood that at least one will be transparent (e.g., borosilicate glass) to allow the base pair reading process. It is also preferred for the upper reference plate 404 and the lower reference plate 406 to have low autofluorescence properties so that they do not generate an undue amount of background light during the base pair reading process.

In use, the flowcell 300 is positioned with the upper film 302 adjacent the upper reference plate 404 and the lower film 304 adjacent the lower reference plate 406, as shown in FIG. 4A. In this position, one or both of positive pressure within the flowcell channel 400 and negative pressure outside the flowcell 300 is used to hold the upper film 302 in contact with the upper reference surface 408, and the lower film 304 in contact with the lower reference surface 410. Negative pressure may be applied by vacuum passages (not shown) extending through one or both of the upper reference plate 404 and the lower reference plate 406, such as described above. Positive pressure may be provided by maintaining the reagents within the channel 400 at a suitable positive pressure using one or more pumps, valves and the like. In one embodiment, a pressure differential of 0.5-5 psi, and more preferably 1-2 psi is used to hold the upper film 302 and lower film 304 against the upper reference surface 408 and lower reference surface 410, respectively.

The height H of the flowcell channel 400 is defined by the distance between the upper reference surface 408 and the lower reference surface 410 and the thicknesses of the upper film 302 and lower film 304. The upper reference plate 404 and lower reference plate 406 may be fixed in place relative to one another during the sequencing operation, in which case the channel height H will remain constant. Alternatively, in some embodiments, the upper reference plate 404 and lower reference plate 406 may be movable relative to each other in order to alter the flowcell channel height H, such as shown in FIGS. 4A and 4B. This may be accomplished using conventional robotic mechanisms, such as motor-driven racks and the like, as will be appreciated by those of ordinary skill in the art in view of this disclosure.

Providing movable reference plates 404, 406 is expected to provide certain benefits. For example, the reference plates 404, 406 may be moved between a first position in which the reference plates 404, 406 are relatively close together, as shown in FIG. 4A, and a second position in which the reference plates 404, 406 are relatively far apart, as shown in FIG. 4B. The first position provides a relatively low channel height H. This provides a relatively high area-to-volume ratio (i.e., the ratio of the combined surface areas of the inner surfaces of the upper film 302 and the lower film 304 to the volume of the channel 400), as compared to the second position. The high area-to-volume ratio decreases the volume of reagent required to perform the desired chemical processes on the DNA templates 402, which can reduce the operation cost of the instrument, because certain reagents can comprise a significant portion of the operating cost. The first position also increases the areas of the films 302, 304 that are in close contact with the respective reference surface 408, 410, which increases the sizes of the operative portions of the films 302, 304 and consequently increases the population count of DNA templates 402 that lie within the depth of field of the microscope's focus plane. This facilitates rapid and accurate base pair reading by the microscope 206 or other optics.

The second position, shown in FIG. 4B, provides a relatively low area-to-volume ratio as compared to the first position. This reduces the flow resistance within the channel 400 and allows reagents to be pumped through the channel with relatively little pressure drop from the fluid inlet 310 to the fluid outlet 312. The reduced flow resistance may facilitate easier and more accurate reagent pumping. The reduced flow resistance is also expected to reduce the magnitude of liquid velocities adjacent the films 302, 304, which reduces the magnitude of shear forces that could strip DNA templates 402 away from the films 302, 304 during the reagent pumping process.

The embodiment of FIG. 3 is used in essentially the same way as the first embodiment. However, if it is desired, additional steps may be added to change the surface-to-volume ratio of the chamber 400 during the sequencing process. This embodiment also provides benefits similar to the first embodiment. For example, the upper film 302 and lower film 304 are pressed into contact with flat reference surfaces 408, 410 during the sequencing process, but are not otherwise required to be made to demanding flatness tolerances. This reduces the cost of the flowcell, and may improve the optical performance of the system. Furthermore, the second embodiment replaces the flowcell plate 102 with an external reference surface 408, which allows DNA templates to be immobilized on the upper film and accurately imaged, without having to provide the flowcell 300 with a flat upper surface. The use of two joined films also can improve the ability to manufacture the flowcell 300 using simple bonding techniques to join the two films together, and also improves the disposability of the flowcell 300. Other alternatives and benefits will be apparent to persons of ordinary skill in the art in view of the present disclosure.

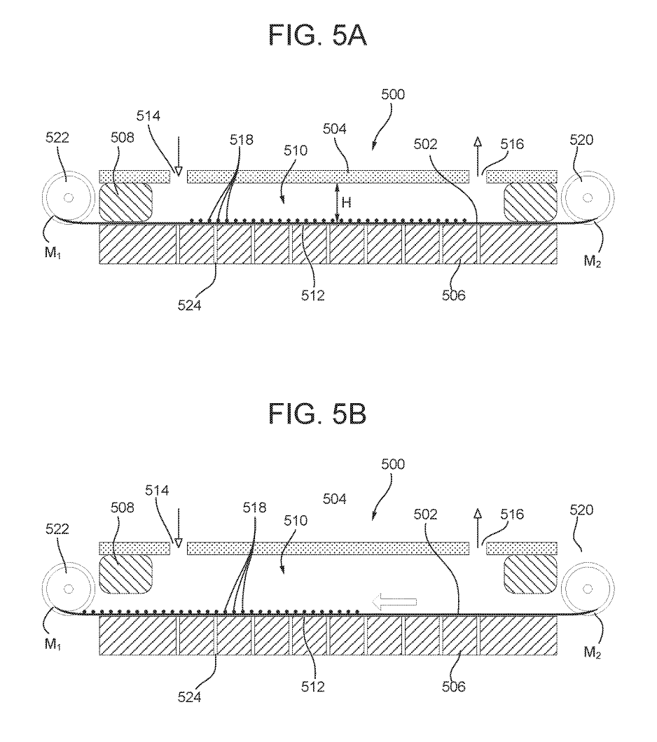

A third embodiment is illustrated in FIGS. 5A and 5B. Here, the flowcell 500 is formed by a film 502 that is captured in place between a cover 504 and a reference plate 506. A gap spacer 508 is located between the cover 504 and the reference plate 506. Together, the cover 504 and the gap spacer 508 form an assembly that defines a cavity in which the flowcell 500 is created. The cover 504 forms the top of the cavity, and the gap spacer 508 forms the outer perimeter shape of the cavity. The cover 504 and gap spacer 508 are placed adjacent the film 502 to form a flowcell passage 510 defined by the shape of the cavity. The height of the gap spacer 508 defines the height H of the flowcell passage 510.

The film 502, cover 504, reference plate 506 and gap spacer 508 may be made like those described in the previous embodiments, or they may have different constructions. For example, the film 502 may comprise a cyclic olefin copolymer material having various chemical coatings or treatments. The cover 504 comprises a transparent material that may include optical coatings or the like and preferably has low autofluorescence properties. The reference plate 506 includes a precision-made flat reference surface 512, preferably having a flatness of 0.05%, which is calculated as the maximum “peak to valley” height variation over a predetermined span of the surface (e.g., a variation in height of no greater than 0.025 millimeters over a distance of 50 millimeters). Other preferred flatness values and other measurement techniques (e.g., the arithmetic mean of the departures of the roughness profile from the mean line) may be used in other embodiments. The gap spacer 508 may comprise any suitable material (e.g., metal, ceramic or plastic) and may be provided as an integral part of the cover 504, as an attachment to the cover 504, or as a completely separate part. The gap spacer 508 may include one or more seals (not shown), such as gaskets or the like, to create a fluid-tight connection between the cover 504 and the gap spacer 508, and between the gap spacer 508 and the film 502. The gap spacer 508 also may have any desirable perimeter shape, such as a rectangle, a “dog-bone” shape, a “dumbbell” shape, multiple channels, and so on, as discussed in relation to the previous embodiments.

One or more of the cover 504, reference plate 506 and gap spacer 508 may be provided as an integral or operative part of an instrument. For example, the cover 504, reference plate 506 and gap spacer 508 may be mounted to an instrument and remain on the instrument during multiple successive and unique sequencing operations.

The flowcell 500 also includes a fluid inlet 514 and a fluid outlet 516. The fluid inlet 514 and fluid outlet 516 may be formed as passages through the cover 504 (as shown), or as passages through other parts, such as the reference plate 506 or the gap spacer 508.

A differential pressure is used to press the film 502 against the flat reference surface 512. The differential pressure may be generated by pressurizing the contents of the channel 510, reducing the pressure at the bottom surface of the film 502, or both. The reference plate 506 preferably includes one or more vacuum passages 524, such as described previously herein. The reference plate 506 also may be connected to (or part of) a thermoelectric heat pump or similar device, such as described above.

This embodiment eliminates the need for a disposable flowcell, per se. Instead, the flowcell 500 is formed as a combination of a disposable film 502 and a reusable cover 504 and gap spacer 508. The film 502 interacts with the reference surface 512 to form a flat object plane perpendicular to the optical path of the microscope or other imaging system, to ensure a large population of DNA templates 518 lie within the depth of field of the microscope, similar to the embodiments described above. As with the other embodiments, the flatness of the plane formed by the film 502 is dictated by the flatness of the reference surface 512 and the thickness uniformity of the film 502.

In use, the film 502 is positioned above the reference surface 512 and below the cover 504 and gap spacer 508, to form the channel 510 that extends from the fluid inlet 514 to the fluid outlet 516. Sequencing is performed within the channel 510, such as by immobilizing DNA templates 518 on the film 502, passing reagents through the channel 510, heating and/or cooling the contents of the channel 510, and so on. During sequencing, the base pair extensions are read through the cover 504 by a microscope or other suitable optics. As with the other embodiments described herein, the base pair reads may be performed periodically, or continuously. During at least the base pair reading steps, a differential pressure is applied to hold the film 502 against the reference surface 512.

When it is desired to commence a new sequencing operation, the cover 504 and gap spacer 508 are moved away from the reference plate 506. This breaks the seal between the gap spacer 508 and the film 502, and rapidly releases any remaining fluid in the chamber 510. One or more fluid ducts (not shown) formed in or adjacent to the reference plate 506 may be provided to control the movement of the fluid as the chamber 510 opens, and the reference plate 506 may be positioned on a tilting platform or be affixed at an angle to help guide fluid removal. The cover 504, gap spacer 508, and other parts also may be coated with a material, such as a nanometer-thick layer of fluorinated compound (e.g., TEFLON™ AF amorphous fluoroplastic available from E. I. du Pont de Nemours and Company of Wilmington, Del.) to help reduce carryover between operation cycles. The cover 504 and gap spacer 508 may be cleaned with a bleaching chemical compound to eliminate cross contamination between sequencing runs. For example, the cover 504 and gap spacer 508 may be moved using robotics to douse them in a bath of bleaching compound between sequencing runs. The existing film 502 is removed and discarded, and a new film 502 is placed on the reference plate 506 to commence growing or placement of new DNA template colonies.

The shown exemplary embodiment uses a spool system to remove and replace the film 502. The film 502 extends between a supply spool 520 and a take-up spool 522. The supply spool 520 holds unused film 502, and the take-up spool 522 holds the used film 502. Once the cover 504 and gap spacer 508 are moved away from the film 502, one or more motors M₁, M₂ may be used to operate one or both of the spools 520, 522 to remove the used portion of the film 502 from the reference plate 508, and advance a new portion of the film 502 over the reference plate 508. For example motor M₁ may be rotated clockwise (as viewed in FIG. 5B) to roll up the used portion of the film 502, and motor M₂ (if provided) or a suitable drag brake may be used to apply tension to the film 502 to draw it generally flat on the reference surface 512.

It will be appreciated that the film 502 may be replaced using other mechanisms. For example, the film 502 may be provided as individual sheets, which may be reinforced around their perimeter using a frame or the like to help facilitate movement without folding or collapsing. As another example, the sheet 502 may comprise a large sheet that is held around its perimeter, and a different portion of the sheet 502 is selectively positioned at the flowcell location during each sequencing run. Other alternatives will be apparent to persons of ordinary skill in the art in view of the present disclosure.

The third embodiment provides an even greater reduction in the use of consumable resources, and is expected to provide a further reduction in operating costs.

While the foregoing embodiments are described as using a differential pressure to hold the film flat against the flat reference surface, other embodiments may not use a differential pressure to accomplish this. For example, the embodiment of FIGS. 5A and 5B may be modified by omitting the vacuum passages 524 and instead stretching the film 502 tight over the reference surface 512. Other alternatives will be apparent to persons of ordinary skill in the art in view of the present disclosure.

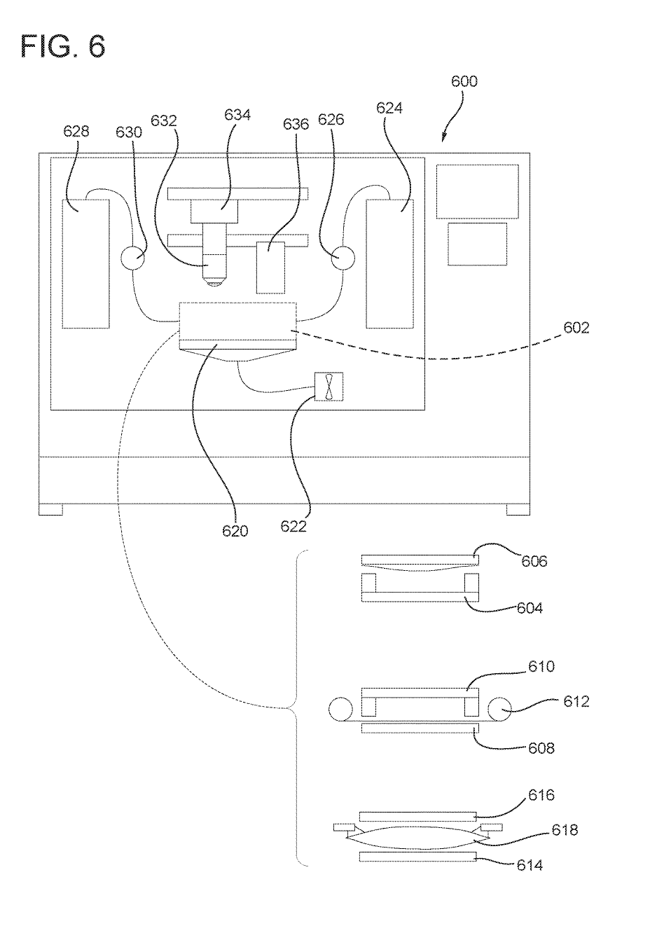

FIG. 6 illustrates how embodiments may be integrated into an instrument 600. The instrument 600 includes a sequencing stage 602 configured as any of the foregoing embodiments or variations thereof. For example the stage 602 may comprise a fixed reference surface/gap spacer assembly 604 that receives self-contained flowcells 606 having a film attached to a rigid plate. Or, the stage 604 may comprise a fixed reference surface 608, movable cover/gap spacer assembly 610, and replaceable film supply 612. The stage 604 also may comprise a lower reference surface 614 and a fixed or movable upper reference surface 616, that receive self-contained flowcells 618 comprising upper joined upper and lower films.

The sequencing stage 602 is associated with (preferably mounted on) a heating device 620 such as a thermoelectric heat pump. A vacuum source 622, such as an air pump, centrifugal fan, or the like, may be provided to draw a vacuum on the bottom of the film to press the film against an associated reference surface. The stage 602 may be connected to a reagent supply 624 via a first fluid pump system 626, and to a reagent waste 628 via a second fluid pump system 630. An imaging system 632 (e.g., microscope, light sources, mirrors, camera, etc.) is mounted above the stage 602, and may be movably mounted on a robotic unit 634. One or more robotic units 636 also may be provided to move various parts, such as flowcells, movable reference plates, movable covers, and so on. Suitable power supplies, electronic controls, network interfaces, and the like also may be provided with the instrument 600. Other alternatives will be apparent to persons of ordinary skill in the art in view of the present disclosure.

The present disclosure describes a number of new, useful and nonobvious features and/or combinations of features that may be used alone or together. It is expected that embodiments may be particularly helpful to reduce the cost of goods associated with high-throughput nucleic acid sequencing systems, but other benefits may be provided, and it will be appreciated that reduced cost is not necessarily required in all embodiments. While the embodiments described herein have generally been explained in the context of sequencing by syntheses processes, it will be appreciated that embodiments may be configured for use in other sequencing processes that use visual observation of chemical labels. The embodiments described herein are all exemplary, and are not intended to limit the scope of the inventions. It will be appreciated that the inventions described herein can be modified and adapted in various and equivalent ways, and all such modifications and adaptations are intended to be included in the scope of this disclosure and the appended claims.

We claim:

1. A flowcell system for a sequencing instrument, the flowcell system comprising:
a fluid inlet configured to receive one or more liquid reagents;
a fluid outlet configured to pass the one of more liquid reagents; and
a channel extending between and fluidly connecting the fluid inlet and the fluid outlet; wherein
at least a portion of the channel comprises a film comprising a flexible material configured to receive a plurality of DNA templates immobilized thereon.

2. The flowcell system of claim 1, wherein the film comprises a polymer or a cyclic olefin copolymer.

3. The flowcell system of claim 1, wherein the film has a thickness of 1 micrometer to 100 micrometers.

4. The flowcell system of claim 1, wherein the film has a thickness of 4 micrometers to 50 micrometers.

5. The flowcell system of claim 1, wherein the film has a thickness of 10 micrometers to 20 micrometers.

6. The flowcell system of claim 1, wherein the film is movable to a position in which at least a portion of the film comprising a plurality of DNA templates lies in a flat object plane.

7. The flowcell system of claim 6, further comprising a flat reference surface, wherein the film is movable to position the portion of the film on the flat reference surface to thereby place the DNA templates in the flat object plane.

8. The flowcell system of claim 7, wherein the flat reference surface has a flatness of 0.05%, as calculated by the maximum peak to valley height variation over a predetermined span of the flat reference surface.

9. The flowcell system of claim 7, further comprising one or more air passages operatively associated with the flat reference surface, and one or more air pumps fluidly connected to the one or more air passages and configured to generate a negative pressure on a side of the film, to thereby position the portion of the film on the flat reference surface.

10. The flowcell system of claim 1, further comprising:
a flowcell plate comprising a rigid material, at least a portion of the flowcell plate comprising a transparent plate region; and
wherein the film is attached at a perimeter region of the film to the flowcell plate, with at least a portion of the film facing the transparent plate region to form the channel between the film and the flowcell plate, and a portion of the film comprising a plurality of DNA templates is movable in a direction away from the flowcell plate to position the portion of the film on a flat object plane.

11. The flowcell system of claim 10, wherein at least one of the fluid inlet and the fluid outlet comprises a respective passage through the flowcell plate.

12. The flowcell system of claim 10, wherein the flowcell plate is configured and dimensioned to fit on a portion of an associated sequencing instrument, and the film is configured to be placed into contact with a reference surface on the associated sequencing instrument upon application of a differential pressure across the film.

13. The flowcell system of claim 1, wherein the film comprises a first film portion and a second film portion, the first film portion and the second film portion being connected to each other at a respective perimeter edge of each to form the channel between the first film and the second film.

14. The flowcell system of claim 13, wherein the first film portion and the second film portion comprise separate sheets of film material bonded together at the perimeter edge, a single sheet of folded film material, or a single tube of film material.

15. The flowcell system of claim 13, wherein the flowcell is configured and dimensioned to fit on a portion of an associated sequencing instrument, the first film portion is configured to be placed into contact with a first reference surface on the associated sequencing instrument upon application of a differential pressure across the first film portion, and the second film portion is configured to be placed into contact with a second reference surface on the associated sequencing instrument upon application of a differential pressure across the second film portion.

16. The flowcell system of claim 15, wherein at least one of the first reference surface and the second reference surface comprises a flat surface.

17. The flowcell system of claim 1, further comprising:
a cover configured to face a first side of the film to form the channel between the cover and the film; and
a reference plate configured to face a second side of the film that is opposite the first side of the film;

18. The flowcell system of claim 17, wherein at least one of the cover and the reference plate is selectively movable to remove the film.

19. The flowcell system of claim 18, wherein the film comprises a discrete portion of a supply of film material.

20. The flowcell system of claim 19, wherein the supply of film material comprises a spooled roll of film material configured to be rotated to move the discrete portion of the supply of film material out from between the cover and the reference plate.

21. The flowcell system of claim 17, wherein the cover comprises a cover plate, a least a portion of the cover plate comprising a transparent cover region, and a gap spacer extending from the cover plate to form a cavity facing the first side of the film, the gap spacer being permanently attached to the cover plate or selectively removable from the cover plate.

22. The flowcell system of claim 17, wherein the fluid inlet and the fluid outlet comprise respective passages through the cover.
